(19) United States
(12) Patent Application Publication
(10) Pub. No.: US 2004/0113734 A1
(43) Pub. Date: Jun. 17, 2004

(54) High density plastic tubing with included power transmission cabling for downhole use in petroleum industry

(76) Inventor: L. Keith Campbell, Calgary (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/704,565

(22) Filed: Nov. 12, 2003

(30) Foreign Application Priority Data
Nov. 12, 2002 (CA) 2,411,597

(51) Int. Cl. H01F 29/00; H01F 27/30

(52) U.S. Cl. 336/70; 336/206

(57) ABSTRACT

The present invention relates generally to provision of electrical power downhole to power tools such as pumps, valves, motor-driven drilling tools, grapples and the like. More particularly, the present invention relates to the provision of electrical power through cables included within the walls of high density plastic tubing used in completion or production techniques in some oil and gas production settings, commonly referred to as “coiled” or “endless” tubing.

### FIELD OF THE INVENTION

The present invention relates generally to provision of electrical power downhole to power tools such as pumps, valves, motor-driven drilling tools, grapples and the like. More particularly, the present invention relates to the provision of electrical power and high-density plastic tubing for use in completion or production techniques in some oil and gas production settings, commonly referred to as “coiled” or “endless” tubing.

### BACKGROUND OF THE INVENTION

It is known in the art of extraction of petroleum products from formation through well-bores to provide a solid walled casing to seal the well-bore from the earth within which it resides to protect its integrity and the integrity of the conduit formed by the casing from production zone to surface. In recent decades, the technique of providing a second conduit within the casing's conduit by insertion of endless or coiled tubing with outside diameter less than the inside diameter of the casing structure has become quite common. There are several reasons for providing that second, included conduit. Some of those reasons are: to provide a conduit from two (or more) different production zones by producing from a segregated region within the casing's length directly to the inserted tubing, by segregating its opened bottom end from the annulus between casing and tubing so that production from that zone can be done through the tubing, while producing from a different zone through the annulus; another sample reason is to provide a conduit of smaller diameter than the casing so that the produced gas will be forced through the small diameter tubing by formation pressure to surface at a much higher velocity, and thus carry with it included liquids which would otherwise collect at the well's bottom end, and eventually the weight of the column of collected fluids in the wellbore would overbalance or shut-in the gas production from formation.

In U.S. Pat. No. 6,357,485B2 (Quigley, et al.) is disclosed a method of construction of a composite endless tubing structure made up of layers of material of different characteristics; for example, an outer layer which is abrasion resistant, a middle layer which has high tensile strength, another middle layer which is of braided cord and provides enhanced burst strength, and an inner layer providing low friction for fluid flow, all while providing a continuous tubing string with bending characteristics to permit it to be rolled onto conventional truck-mounted reels for use in the oil industry. While useful, this invention addresses requirements for a varied blending of characteristics of tubing, but provides no assistance with operating machinery downhole.

In U.S. Pat. No. 6,361,299B1 (Quigley et al.) is provided an endless tubing string with optical fiber (or similar energy conductor) communicating between an included sensor (or string of sensors) in the tubing and the surface such that the state of the sensor (and thus an inference of what it is designed to sense) can be communicated to surface equipment. Again, this fails to assist with operation of downhole equipment. Likewise, U.S. Pat. No. 6,004,639 provides for a similar sensor and communication conduit system embedded or included within the wall of an endless spoolable tubing string for use in the oil industry.

In U.S. Pat. No. 5,920,032 (Aeschbacher et al.) a rigid tubing string is provided with a centralizer within which power cable and signal conductors are deployed, and around which centralizer can be installed insulation, stiffening matter, or alternatively the voids within the tubing formed by the centralizer can be used to convey fluid or fluid pressure downhole. While of interest, it is to be noted that this system is rigid or semirigid, is not a continuous spoolable tubing string, is difficult to manufacture, and provides quite a large impairment of free flow within the tubing's central void by interrupting the space with the centralizer and conduits.

In U.S. Pat. No. 5,554,425 (Krause et al.) is disclosed a method of manufacturing continuous tubing from flouropolymers in several layers using extrusion and then co-extrusion in series. While of some interest in providing a multi-layered composite tube structure, and of some interest in the manufacturing process, neither the technique nor the resulting product is very helpful in providing endless spoolable tubing strings or assistance with operating machinery downhole.

U.S. Pat. No. 5,334,801 (Mohn) discloses a method of providing connectable series of pipe segments with included power cable in or on the pipe segments' walls, to form a continuous set of electrical circuits notwithstanding the juncture's coupling mechanism must provide for sealing of the pipe segments one to the other, as well as providing de-couplable structural joints. Another interesting concept, but this fails to provide for the more efficient continuous spoolable plastic coiled or endless tubing systems preferred in modem completion and production settings.

None of the prior art accessible to the inventor succeeds in providing the desired characteristics to the art of oil and gas well completion and production using endless or coiled tubing made from plastics while at the same time providing means of assisting in the operation of machinery downhole.

It is, therefore, desirable to provide a system of coiled tubing made from plastic which provides assistance in the operation of machinery downhole, and to overcome the shortcomings of the prior art.

### SUMMARY OF THE INVENTION

It is an object of the present invention to obviate or mitigate at least one disadvantage of previous systems noted above.

In a first aspect, a coiled tubing string is provided for conducting electric power to a downhole location to provide power to downhole machinery. The tubing string comprises flexible tubing defined by a homogeneous wall of embedding material, the tubing wall having an interior surface and an outer surface; and at least one electrically conductive cable embedded within the wall between the interior surface and the outer surface, the at least one cable extending axially along the tubing for conducting electric power along the length of the tubing.

In one embodiment, the cable is copper wire, which may be from about 10 gauge to about 4 gauge copper wire. Preferably, the wire is insulated, for example flat ribbon-cable, with each wire lead separately insulated.

In a further embodiment, the coiled tubing is capable of providing power to a downhole tool, which may be a pump, a drill, a heater, a sonic source, a mechanical energy source, or any other electrically powered tool that may be used downhole.

In another embodiment, the embedding material is a plastic, preferably a high-density polyethylene. The thickness of the wall should be similar to that known in the art, preferably having a thickness between 0.25 and 5.25 inches.

In a second aspect, a coiled tubing is provided comprising an inner tubing layer of a first flexible material; an outer tubing layer of a second flexible material, and at least one electrically conductive cable disposed between the inner tubing layer and the outer tubing layer such that the cable is effectively embedded between the tubing layers, the at least one cable extending along the entire length of the tubing for conducting electric power along the length of the tubing.

In one embodiment, the first or second flexible material is a high-density polyethylene. Preferably, both the first and second materials are high-density polyethylenes.

In a third aspect, the present invention provides a method of constructing an endless or coiled tubing string of plastic by two extrusion steps with an intermediate wiring step.

A further aspect provides a method to manufacture coiled tubing comprising the steps of: extruding a first flexible tubing, laying at least one electrically conductive cable against the outer surface of the tubing such that the cable extends along the entire length of the tubing, and passing the flexible tubing and cabling through a co-extrusion device to extrude a second layer of flexible tubing over the outer surface of the first tubing, thereby embedding the cabling between the first and second flexible tubing layers.

In one embodiment, the co-extrusion device is an extruder and crosshead die. In another embodiment, the step of laying the cable over the first tubing layer occurs while the first flexible tubing layer is still tacky from the extrusion process, such that the cable will adhere to the surface of the first tubing layer.

The coiled or endless tubing string with included power cabling is capable of conveying electrical power downhole to operate and power machinery in situ from surface without having to rely upon pressure or fluid flows or other complex energy transmission means such as rods, rotating tools, or the like.

In further aspect, the present invention provides an improved method, using the coiled tubing with embedded cabling, of powering tools downhole. Such tools may include a pump, a drill, a motor, a heater, a sonic source, a mechanical energy source or any other electrically powered tool that may be used downhole.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a cutaway cross-section of the tubing once built

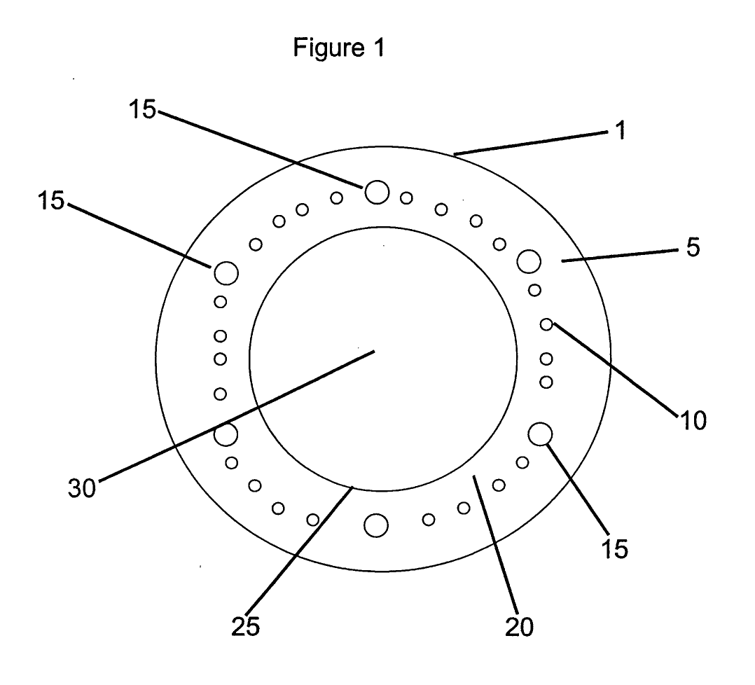

FIG. 2 is a block diagram describing the steps for manufacturing the coiled tubing

FIG. 3 is a cross-section of the tubing installed within a wellbore casing

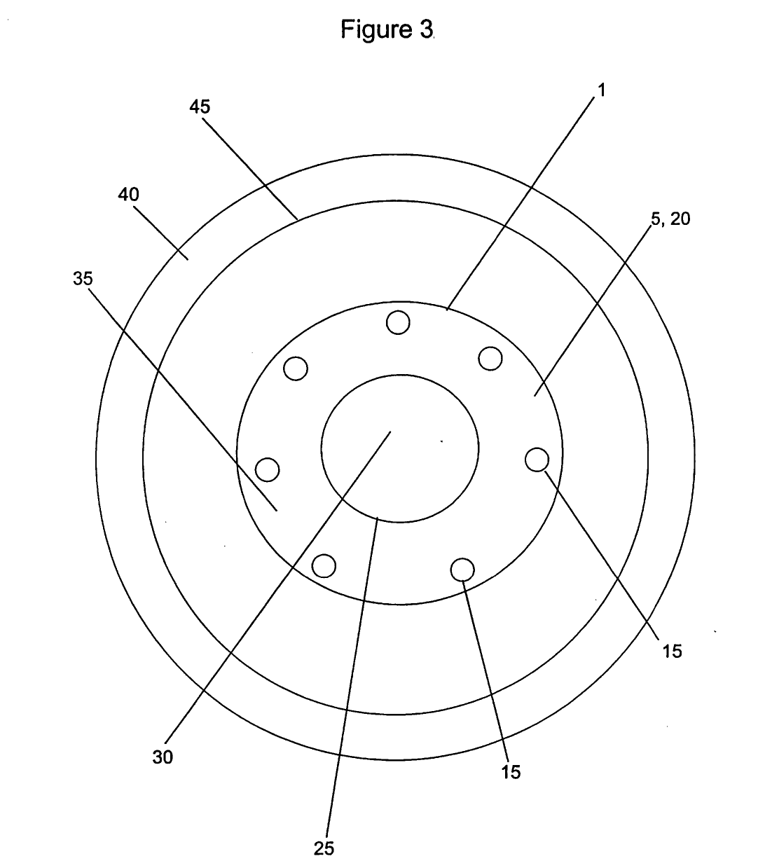

### DETAILED DESCRIPTION

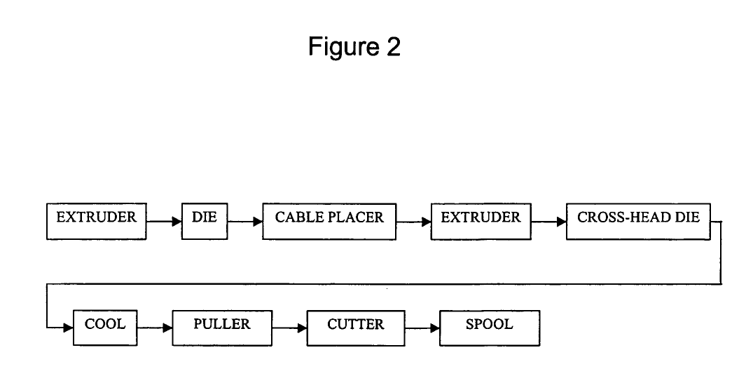

The tubing comprises an outer surface 1, a wall structure made of at least two parts 5 and 20 which are formed into one by joining typically by melting at their interface 10 during the extrusion and co-extrusion process (FIG. 2), embedded or included cables 15, and a smooth inner surface 25 with a conduit or void 30 in the center.

The tubing is constructed by first extruding an inner layer 20 with smooth interior surface 25 forming a void or conduit 30 and a temporary outer surface at 10; electrical conducting cabling 15 is laid onto the outer surface 10 while that surface is tacky; the tubing Is pulled through a co-extrusion device (extruder and cross-head die) and a second layer of plastic 5 is extruded over the first tubing to form a single-walled tube with included power cable. The inner diameter and outer diameter, wall thickness and cable material and thickness may be varied to obtain desired performance characteristics for use In production and extraction of petroleum products from formation using conventional coiled-tubing rigs, packers, sealers, and equipment.

When in a wellbore with casing 40, the tubing string 1,5,10,20,15 will have an inner conduit 30 of appropriate size to, for example, permit high-velocity production of gas and included liquids to avoid accumulation of produced liquids in the wellbore. Alternatively (or as desired), the annulus between the inside surface of the casing 45 and the outside surface of the tubing 1 can be used as a second conduit for production from the wellbore, the introduction of pressurized material into the wellbore, or as otherwise desired. The invention provides several added power conducting cables 15 to provide electrical power from surface to the bottom of the tubing string to operate relatively heavy-load equipment such as pumps, drills, and the like. Similarly, the same conductors can be used to either simultaneously or separately provide a means of conducting electrical or electromagnetic signals either to or from surface and either from or to sensors or equipment downhole.

The conductors 15 can be insulated or uninsulated prior to installation in the manufacturing process. The layers of the plastic extrusion may be more than two, and may be of different substances. As noted in the prior art discussion, there may be layered within the tubing composite layers of differing materials to provide different characteristic mixes to the final construct, provided that there is embedded wiring between two extruded layers, which should preferably bond one to the other without leaving any voids or non-bonded surfaces at their place of meeting 10.

The above-described embodiments of the present invention are intended to be examples only. Alterations, modifications and variations may be effected to the particular embodiments by those of skill in the art without departing from the scope of the invention.

The tubing is contemplated to be manufactured of high-density polyethylene or similar plastic extruded in a continuous process, the first step being to extrude a tubular shape with an inside diameter (ID) as desired in the final product, immediately following that extrusion process, power cabling comprising (typically) electrically-conductive metallic power leads which may or may not be separately insulated is laid onto the outer surface of the tubing which surface is preferably still tacky from the initial extrusion process, and following which the tubing with cabling has a further outer coating of the (probably the same but not necessarily so) high-density polyethylene or similar plastic extruded onto its outer surface to an outer diameter (OD) desired in the finished product, which may involve milling as a final step. Ideally, the two extrusions of plastic meld and form one body with the cabling embedded seamlessly within the body. Other embodiments may include different layers of laminated plastics of different types (for example, outer surface may be abrasion-resistant and inner surface may be corrosion-resistant or load-bearing, or have other characteristics which are complementary to the tubing string's eventual purpose).

For utility in the planned application, which is to provide useable electrical power (i.e. not signals, but electricity to power mechanical devices) to bottom hole via a continuous (or relatively continuous) tubing string to power things like valves, pumps, drive motors, etc., the cabling is likely ID be minimum 10 gauge wiring to probably 4 gauge copper wiring. The wiring is preferably premanufactured in rolls of flat ribbon-cable, each wire lead separately insulated.

The tubing's wall thickness and materials must maintain desirable characteristics within temperature ranges of approximately −40 to +40 degrees Celsius. Desirable characteristics include wall strength to withstand a pressure differential between the tubing's interior and its exterior of in the range of 2,000 pounds burst pressure. Other desirable characteristics include resistance to longitudinal stretching, and the ability to bear a longitudinal load. Typical tubing sizes might be from 1 and ¼″ to 6″ OD (typically 3″) with ID, respectively relative to the list of ODs above, of ¾″ to 3″ (typically 1″), resulting in a wall thickness of approximately 0.25 to 5.25 inches.

What is claimed is:

1. A coiled tubing string for conducting electric power to a downhole location comprising: flexible tubing defined by a homogeneous wall of embedding material, the wall having an interior surface and an outer surface; and at least one cable embedded within the wall between the interior surface and the outer surface, the at least one cable extending axially along the tubing for conducting electric power along the length of the tubing.

2. The coiled tubing string of claim 1 wherein the at least one cable is copper wire.

3. The coiled tubing of claim 1 wherein the cable is capable of providing power to a downhole tool.

4. The coiled tubing of claim 3 wherein the downhole tool is a pump, a drill, a heater, a sonic source, or a mechanical energy source.

5. The coiled tubing string of claim 2 wherein the copper wire has a thickness between about 10 gauge and about 4 gauge.

6. The coiled tubing string of claim 1 wherein the at least one cable is insulated wire.

7. The coiled tubing string of claim 1 wherein the homogeneous embedding material is high-density polyethylene.

8. The coiled tubing string of claim 1 wherein the wall of embedding material has a thickness of about 0.25 inches to about 5.25 inches.

9. A coiled tubing string for conducting electricity to a downhole location comprising: an inner tubing layer of a first flexible material; an outer tubing layer of a second flexible material; and at least one electrical cable disposed between the inner tubing layer and the outer tubing layer such that the cable is effectively embedded between the tubing layers, the at least one cable extending along the entire length of the tubing for conducting electricity along the length of the tubing.

10. The coiled tubing of claim 9 wherein the cable is capable of providing power to a downhole tool.

11. The coiled tubing of claim 10 wherein the downhole tool is a pump, a drill, a heater, a sonic source, or a mechanical energy source.

12. The coiled tubing string of claim 9 wherein the first flexible material is high-density polyethylene.

13. The coiled tubing string of claim 9 wherein the second flexible material is high-density polyethylene.

14. A method for manufacturing coiled tubing comprising the steps of:
extruding a first flexible tubing, the tubing having an interior surface and an exterior surface;
laying at least one electrically conductive cable against the outer surface of the tubing such that the at least one cable extends along the entire length of the tubing;
passing the flexible tubing and attached cabling through a co-extrusion device to extrude a second layer of flexible tubing over the outer surface of the first tubing, thereby embedding the cabling between the first flexible tubing and the second flexible tubing layer.

15. The method of claim 14 wherein the co-extrusion device comprises an extruder and crosshead die.

16. The method of claim 14, wherein the step of laying the cable over the outer surface of the first flexible tubing occurs while the first flexible tubing is tacky, such that the cable adheres to the outer wall of the first flexible tubing.
